(19) United States
(12) Patent Application Publication
(10) Pub. No.: US 2013/0173428 A1
(43) Pub. Date: Jul. 4, 2013

(54) AUGMENTING PRODUCT INFORMATION ON A CLIENT DEVICE

(71) Applicant: MARTIN MOSER, Speyer (DE)

(72) Inventor: MARTIN MOSER, Speyer (DE)

(21) Appl. No.: 13/339,392

(22) Filed: Dec. 29, 2011

(51) Int. Cl. G06Q 30/06

(52) U.S. Cl. 705/26.62

(57) ABSTRACT

Techniques for augmenting information related to a product captured at a client device are described herein. In one aspect, information for the product is captured at the client device. One or more data sources are chosen for extracting additional product data. The one or more data sources are selected from a set of data sources based on a registered characteristic of the data sources. In a further aspect, one or more data queries are sent to the selected one or more data sources, where data queries are generated based on the captured product information. In yet another aspect, the captured information for the product is augmented with the data retrieved by the one or more queries from the selected one or more data sources.

### BACKGROUND

While shopping, it is often difficult to evaluate whether a particular product or item is a good deal or not. There are numerous factors that could impact a decision to buy or not to buy. Typically, the offer price of the item is one of the main criteria for evaluating an offer. However, there are other factors that are also important, such as, the technical specification of the product, quality, provided guarantee, return policies, buyback options, user experience, etc. There are a number of resources that provide information about many of the products available in the market. For example, there are technical specifications, brochures, product analyses, etc. Furthermore, there are special magazines or services concerned with analyzing the marketed items, and rating them based on different criteria. With the rapid development of the Web technologies, almost every bit of information regarding a product could be found online, especially information on price and quality. Thus, the potential customers may conduct thorough investigation to evaluate a particular offer using resources available online.

Analysis of product quality and price, especially in comparison with other similar products, may require a lot of time and effort, e.g., for information lookup, reading of specifications, comparing reviews, etc. Furthermore, such online investigations could be burdensome for many of the potential customers, e.g., it can require motivation, special knowledge and some skills. Even when a customer has the skills and is motivated to evaluate a particular offer, he or she may not have the opportunity to do it. For example, while shopping, when a buy or not buy decision has to be taken, the customer may not have the time or the right means to find and access such product information.

### SUMMARY

Various embodiments of systems and methods for augmenting product information on a client device are described herein. Information for a product is captured at the client device. The captured information should be sufficient to identify the product. According to one aspect, one or more publishers of product data are selected based on at least one property of interest associated with the product. The publishers may be selected from a set of registered publishers, where the registration of a publisher includes at least one type of the data available at the publisher. According to another aspect, at least one data query is sent to the selected one or more publishers, where the at least one data query is generated based on the captured product information. According to yet another aspect, the data received from the selected one or more publishers is consolidated, and used to augment the captured product information at the client device.

These and other benefits and features of the embodiments will be apparent upon consideration of the following detailed description of preferred embodiments thereof, presented in connection with the following drawings.

### BRIEF DESCRIPTION OF THE DRAWINGS

The claims set forth the scope with particularity. The embodiments are illustrated by way of example and not by way of limitation in the figures of the accompanying drawings in which like references indicate similar elements. The embodiments, together with its advantages, may be best understood from the following detailed description taken in conjunction with the accompanying drawings.

FIG. 1A is a block diagram illustrating an exemplary architecture of a solution for augmenting captured product information, according to one embodiment.

FIG. 1B is a block diagram illustrating an exemplary architecture of a solution for augmenting captured product information, according to one embodiment.

FIG. 2 is a flow diagram illustrating a process for augmenting product information, according to one embodiment.

FIG. 3 is a flow diagram illustrating a process for comparing two products based on augmented product information, according one embodiment.

FIG. 4 is a flow diagram illustrating a process for retrieving product data from one or more publishers, according to one embodiment.

FIG. 5 is a block diagram illustrating computer system landscape used for augmenting product information, according to one embodiment.

FIG. 6 is a block diagram of an exemplary computer system to execute computer readable instructions for augmenting product information, according to one embodiment.

### DETAILED DESCRIPTION

Embodiments of techniques for augmenting product information at a client device are described herein. In the following description, numerous specific details are set forth to provide a thorough understanding of the embodiments. One skilled in the relevant art will recognize, however, that the presented ideas can be practiced without one or more of the specific details, or with other methods, components, materials, etc. In other instances, well-known structures, materials, or operations are not shown or described in detail to avoid obscuring.

Reference throughout this specification to “one embodiment”, “this embodiment” and similar phrases, means that a particular feature, structure, or characteristic described in connection with the embodiment is included in at least one embodiment. Thus, the appearances of these phrases in various places throughout this specification are not necessarily all referring to the same embodiment. Furthermore, the particular features, structures, or characteristics may be combined in any suitable manner in one or more embodiments.

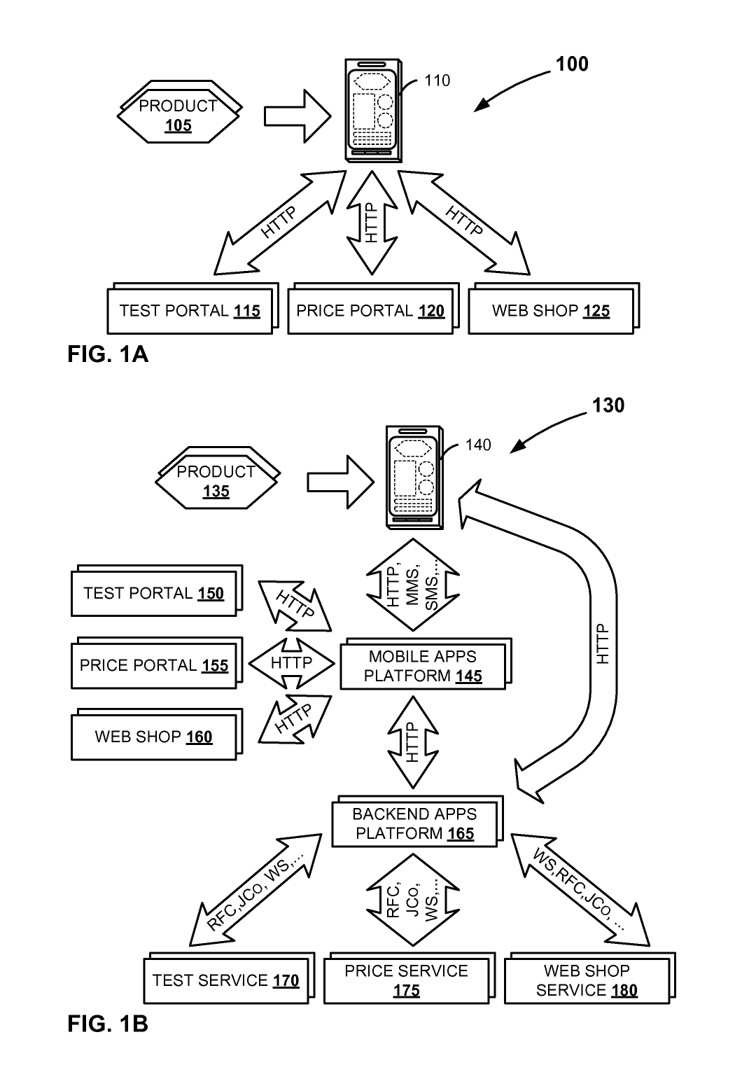

According to one embodiment, the problem of finding easy and timely information for particular products could be resolved by utilizing various mobile and/or wireless technologies. For example, as illustrated in FIG. 1A, a handheld client device, e.g., a smart phone, tablet, etc., may be used in landscape 100 to capture data for one or more products 105. As simply as it could be, a customer may point his or her camera-enabled mobile phone 110 at a particular item of interest and take a snapshot. Specialized mobile applications (or apps for short) could extract identification information from the snapshot, e.g., identification code, product model based on shape and/or color, etc. Alternatively, the mobile device may read radio-frequency identification (RFID) tag or tags assigned to products 105. One of ordinary skills in the art would recognize that there are various technologies or means to capture product information using different client devices.

Once the product 105 is identified, the client device 110 may automatically generate one or more data requests and route them to a number of data sources providing product data. For example, the client device 110 may query one or more test portals 115 publishing technical data for different products on the internet. Similarly, one or more price portals 120 may be queried for different prices of the product 105 at different locations, e.g., regular shops, web shops, etc. Other types of information for the product 105 may be requested from other kinds of resources, e.g., available online. For example, the mobile device 110 may access social networks where users of the product 105 share opinions. Further, the manufacturer of product 105, or the retail store where the product is offered may provide data accessible by the client device 110.

The client device 110 presents or displays the data received in response to the generated requests. In one embodiment, one or more mobile apps may automatically store and digest the received data. The result may be presented to the holder of the handheld device 110 in an easy to read and comprehend format. In one embodiment, the client device 110 augments the captured information for the product 105 with the data received in response to the queries sent to the different portals 115 and 120. Thus, when the potential customer points his or her mobile device 110 at the specific product 105, he or she may almost instantly see the image of the product 105 augmented with quality test data and the best offers on the screen of the device 110. In one embodiment, the client device 110 may further provide interface to a web shop 125 where the customer may directly buy the product 110.

The landscape 100 shows a rather simplified embodiment of a solution for augmenting product information directly at the client device 110. The device 110 possesses all the necessary functionality to identify and query portals 115 to 125 for information and/or services, e.g., using hypertext transfer protocol (HTTP). However, even if a client device is powerful enough to run applications with the necessary functionality, it may require longer time to check the portals available online, create unique requests for each portal, pay for the data based on the business models of the different portals, analyze and consolidate the received data, etc. The information available online changes dynamically, as well as the way this information is presented. Some publishers require subscriptions, others charge for every data request. Some publishers do not even provide data interface, e.g., application programming interface (API), Web-service, etc. Some of the data requests sent to the publishers may have different formats, including requests sent separately to a same portal. Generally, the formats of the data requests processed by a publisher are subject to dynamic change, as well as the requested information changes dynamically. For all these reasons, it may be inefficient to use applications running at the client device to directly extract product data from online data sources.

FIG. 1B shows landscape 130 of a solution for augmenting information of one or more products 135 captured at a device 140, according to one embodiment. A practitioner would recognize that device 140 may be any kind of client computer system, or a peripheral device of a client computer system. For easier description of the idea, it may be assumed that device 140 is a mobile handheld device, e.g., smartphone, tablet, etc. The mobile device 140 captures and recognizes product 135, e.g., by using camera or radio circuit to scan a barcode, quick response (QR) code, RFID tag, etc., and a corresponding application providing optical character recognition (OCR), 3D recognition, etc. In one embodiment, a user may simply type-in identification information for the product 135. The identification information is then forwarded to mobile application platform 145. In one embodiment, the identification of the captured product 135 is accomplished at mobile application platform 145 based on the captured information. For example, a snapshot of the product 135 may be directly broadcasted or replicated by the mobile device 140 to the mobile application platform 145 via data transfer (e.g., HTTP message, multimedia message service (MMS) message, etc.).

In one embodiment, the mobile application platform 145 acts as a server for the client device 140. In one embodiment, the communication with data publishers such as test portals 150 and price portals 155, as well as with web shops 160, may be accomplished directly by the mobile application platform 145. Based on the received identification of product 135 and the desired service, mobile application platform 145 could create and send data requests to the portals 150 to 160. Further, the mobile application platform 145 may store a dynamic list of portals 150 to 160 available for particular services together with the supported data exchange formats and protocols. The mobile application platform 145 may even store cached data for the product 135 that can be reused for further requests and/or by other customers. The mobile platform 145 may be hosted by a third party vendor, and could be available as a service to mobile apps developers. For example, one embodiment may include Sybase Unwired Platform® developed by Sybase Inc., an SAP AG company.

In one embodiment, mobile application platform 145 connects to one or more backend application platforms 165 run by one or more enterprises or other entities. For example, the company manufacturing product 135 may run backend application platform 165 providing access to product data, e.g., at test service 170 and price service 175. Also, the manufacturer of product 135 may provide a gateway to web shop services 180 via backend application platform 165 where the product 135 may be ordered. Similarly, a company running a retail shop may open its backend application platform 165 to request for more information about the products 135 available in the store.

For example, the company SAP AG is the vendor of NetWeaver® application platform. An entity, e.g., a customer of SAP AG, may use NetWeaver® platform to integrate a number of backend software solutions, including customer relationship management (CRM) system, enterprise resource planning (ERP) system, supply change management (SCM) system, etc. A NetWeaver® Gateway technology may be used to enable communication between the mobile aps platform 145, and various enterprise systems and/or services that are available at the backend apps platform 165. In one embodiment, the mobile application platform 145 and backend application platform 165 communicate, e.g., using representational state transfer (REST) services over HTTP protocol. The backend software solutions integrated or available at platform 165 may provide data related to product 135 in response to requests sent by the applications running at mobile application platform 145. The product data retrieved from the backend software solutions may augment the captured product information and is pushed back to the mobile device 140.

In one embodiment, the software solutions available to the backend application platform 165 may include external services hosted by the same company or by a third party. For example, a retail company may operate a chain of stores, and provide data related to the quality and prices of the products available at the different stores via test service 170 and price service 175. Additionally, the same retail company may also operate a web shop service 180 for online sales. In one embodiment, some or all of test services 170, price services 175 and web shop services 180 may be hosted by third parties, and may be available to the backend application platform 165 through Web-service (WS) interfaces. When hosted internally, the communication between services 170 to 180 and the application platform may utilize various standard or proprietary interfaces, such as, but not limited to remote function call (RFC) interface and SAP Java connector (JCo). In one embodiment, the mobile device 140 may run applications connecting directly to the backend application platform 165 and exchanging data with services 170 to 180 without engaging the mobile application platform 145.

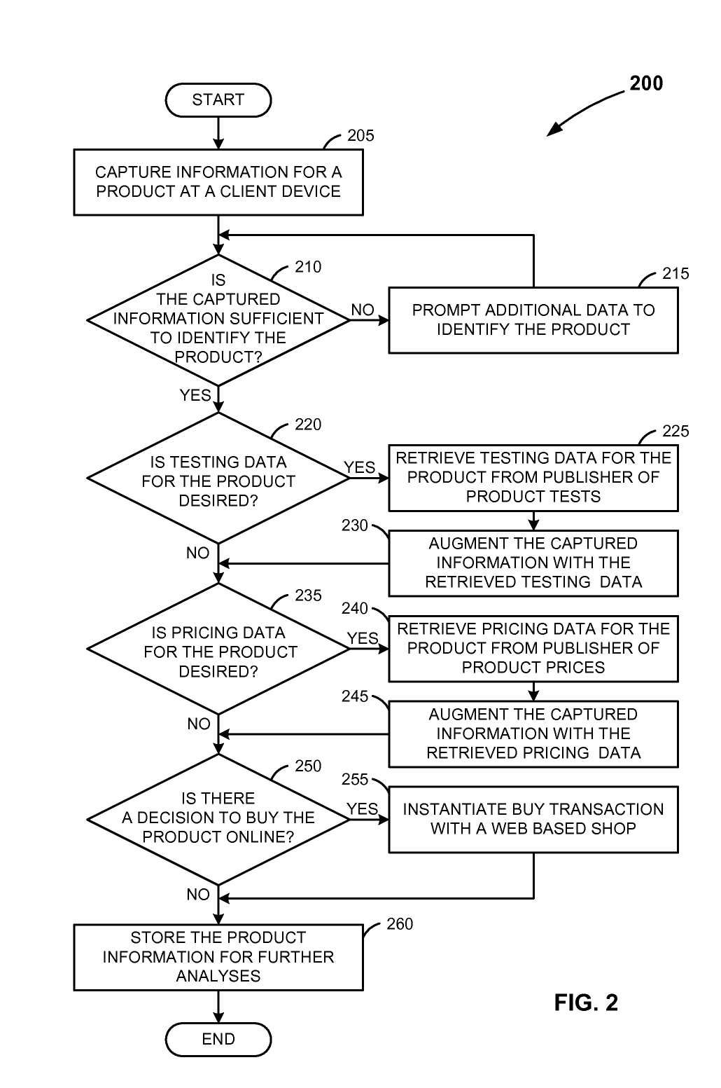

FIG. 2 shows process 200 for augmenting product information, according to one embodiment. As illustrated in relation to FIG. 1A and FIG. 1B, product information may be augmented on a client device using solutions with different architecture. However, in each case, information for a product should be captured or entered, e.g., at a client device (205). Thus, the product of interest becomes present or “known” at the client device for augmenting. Several techniques for capturing information of a product were mentioned above. Besides using a camera and/or a radio circuit to capture shapes or codes, the mobile device may receive product information as an instant message (e.g., including MMS and short message service (SMS)), Web advertisement, email, etc. Additionally, a user may manually type-in product information.

At 210, a check is performed to verify whether the captured information is sufficient to identify the product. The check at 210 may be performed at the client device. Alternatively, the captured information may be sent to a server, e.g., to an application platform, where it may be evaluated and/or used to search the particular product in local or distributed databases. If the product lookup does not generate results, or more than one product matches the search criteria, the user is prompted to enter or capture additional information at 215. The client device or the involved application platform may store or access lists of products, e.g., in external databases hosted by third parties, for which the augmentation solution is supported.

When the captured or entered information is sufficient for identifying the product, process 200 continues at 220 with a check on whether testing data is desired for the product. For example, a user may not be interested in the quality of a particular product, but may want to just compare the price of the product at different locations. Therefore, the user may somehow mark or assign his interest about what product data to receive. For example, a user may predefine what data he or she desires to receive in addition to captured information for a product. Alternatively, the user may be prompted during the augmenting process. When desired, testing data for the product quality is retrieved from a publisher of technical data and/or product tests at 225.

Depending on the embodiment, the retrieval of testing data may be managed either directly by the client device or by a server system to which the device operates as a client, e.g., by a mobile or a backend application platform. At 225, more than one publisher may be queried for information regarding product quality. Besides technical specifications and testing results, the publishers may provide user reviews, classifications, recommendations related to the product, etc. Some of the retrieved data may be indirectly related to the product, e.g., the level of service support, references for the manufacturer, etc.

At 230, the captured information for the product is augmented with the testing data retrieved at 225. Before the augmenting, the data retrieved from different sources may be consolidated. Each of these tasks, the consolidating and augmenting, could be executed at the client device, at a server system (if included in the solution), or may be distributed between the client device and the server system. For example, the client device may receive the retrieved data and could add it to a captured screen image of the product. Alternatively, the server system may prepare the augmented product information as a compilation between the captured product information received from the mobile device and the retrieved testing data from one or more publishers. The server system may then push the augmented product information back to the client device for display.

Process 200 continues at 235 with a check on whether pricing data for the product is desired. Pricing data is retrieved at 240 from one or more publishers of product prices when there is an indication, either preemptive or prompted, that such data for the product is desired. For example, an online pricing portal may be queried for the prices of the product in different stores at different locations, including online stores. This would enable the user to decide whether and where to buy the product. The pricing data may be received from more than one data sources. At 245, the captured product information is augmented with the retrieved pricing data. Again, the augmenting may take place directly at the client device, at the server system if such a system is included in the solution architecture, or at both.

Based on the captured and/or augmented information for the product, a user may decide whether or not to buy the product online at 250. When a ‘to buy’ decision is made, a buy transaction with a Web based shop is instantiated at 255. The buy transaction may be instantiated either by the mobile device or by the server system, depending on the solution architecture. In one embodiment, the Web based shop determines the interface with the user. For example, if the Web shop is an online store hosted by a third party, the user of the client device may have to execute the buy process through the corresponding user interface of the Web shop as a regular customer. If the Web shop service is available at an application platform, the buy transaction may be executed transparently to the user based on the captured product data and the user credentials (e.g., provided through the client device).

In one embodiment, at 260, the product information is stored for further analysis. For example, the product identification information may be added to a list of products, stored either at the mobile device or at the server system. The captured information and/or the retrieved data for one or more products stored at 260 may be reused for reporting purposes, comparison between products, various notifications, etc.

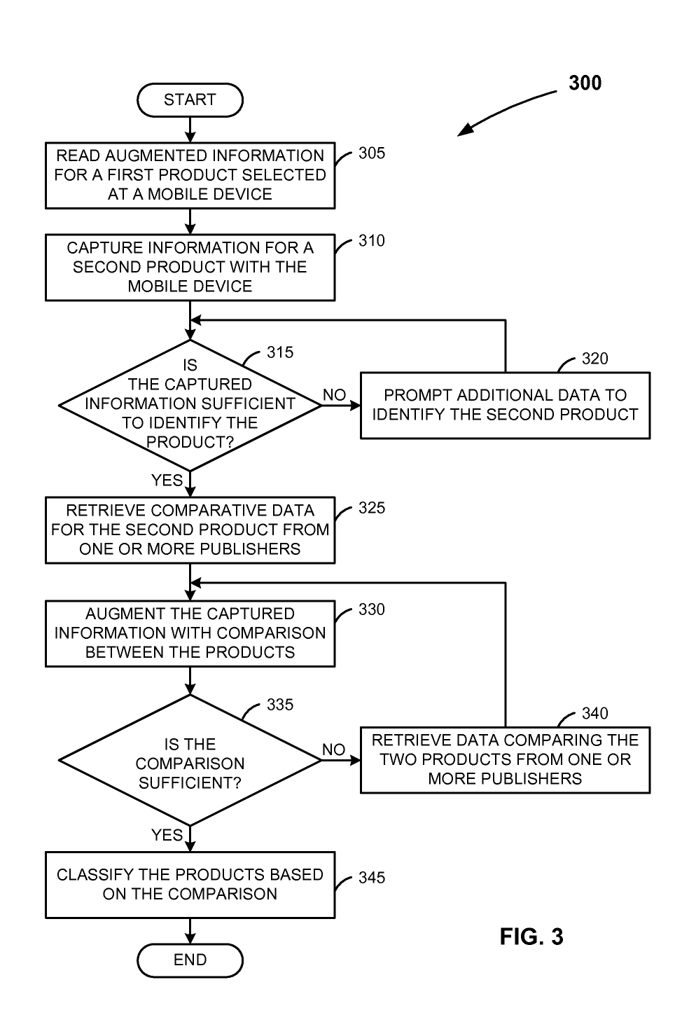

FIG. 3 illustrates an exemplary process 300 for comparing two products, according to one embodiment. At 305, previously stored information for a first product is read. The first product may be selected at a client device. For example, a user may enter, or directly capture, identification information for the first product at the client device. In one embodiment, a user selects the first product from a list of products. The information for the selected first product may be stored locally at the client device, or at a server system, such as, mobile application platform, backend application platform, etc.

Process 300 continues at 310 with capturing information for a second product at the client device. If the check at 315 shows that the captured information is not sufficient to identify the second product, additional data for the second product may be prompted at 320. For example, the user of the client device may be notified to enter or capture further characteristics of the second product, e.g., different shape, model modification, color, etc.

When the product is sufficiently identified by the captured information, process 300 continues at 325 with retrieving comparative data for the second product from one or more publishers, e.g., Web-portals, service providers, etc. Depending on the embodiment, the comparative data may be retrieved with queries generated at the client device and/or at a server system for the client device when present. The retrieved data should be comparable with the information read for the first product. Therefore, the data requests sent to the publishers may be based on the format or the content of the information read at 305, according to one embodiment.

At 330, the captured information for the second product is augmented with comparison between the products. The comparison may be a result from a processing of the information read for the first product at 305 together with the data retrieved at 325. The processing may involve identifying matching features of the products, comparative analysis of similar parameters of the products, etc. The augmenting of the captured information for the second product with the comparison may take place at the client device and/or at the server system. When the check at 335 shows that the comparison is not sufficient, e.g., that more information is necessary to distinguish the two products, additional data comparing the two products may be retrieved at 340 from one or more publishers. The additional comparison data is used at 330 to augment further the captured information. At 345, the two products may be classified based on the comparison. Thus, for example, a user may decide which product would be preferable based on factors like quality, price, customer satisfaction, etc.

In one embodiment, information for two or more products may be captured at the same client device, either together or consecutively. Thus, it will not be necessary to read stored information for any of the products. The comparative data may be retrieved simultaneously for the two or more products from the publishers using appropriate data requests based on the identification data captured for the two or more products.

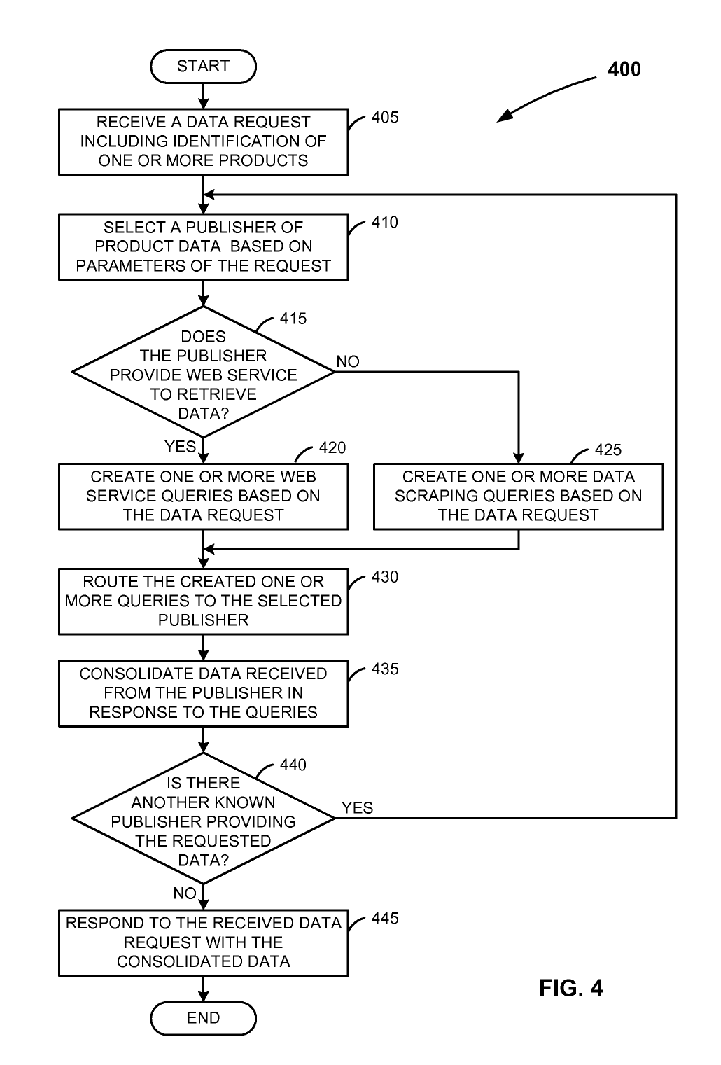

FIG. 4 shows process 400 for retrieving data for one or more products from one or more publishers, according to one embodiment. At 405, a data request is received, where the data request includes identification of one or more products. In one embodiment, the data request is received at a server computer system. The originator of the data request may be a client computer system, e.g., a mobile device that has captured identification information for the one or more products. In one embodiment, the client computer system does not connect to a server computer system. Accordingly, the data request may not be generated. Therefore, in one embodiment, the action corresponding to block 405 may be omitted in process 400.

At 410, a publisher of product data is selected based on parameters of the data request. Such parameters may specify what kind of data is requested. For example, data regarding the quality of the one or more products may be requested, and hence, a publisher providing testing data is selected. If the kind of requested data is not specified, a publisher providing any product information may be selected at 410. In one embodiment, the publisher may be selected from a set of data portals registered with the client computer system or with the server computer system, depending on the architecture of the solution.

The registration of a publisher or a data source may include one or more characteristics of the data source, such as, types of data available at the data source, the structure of the published data, interface definition, uniform resource locator (URL) of the data source, the cost of the data access, the method of payment, etc. The registration of publishers may be dynamically updated to provide actual information. The kinds of data sources in the set may not be as broad as allowed by the solution architecture, including Web portals, databases available over public or private networks, third party service providers, service providers internal to the server system, etc. For simplification, it could be assumed that the publisher selected at 410 is a Web-portal. A practitioner would recognize that the rationale of the presented process applies to other kinds of publishers as well.

At 415, a check is performed regarding how the data provided by the selected publisher is to be accessed. In particular, the check at 415 verifies whether the publisher provides Web-service to retrieve data. If Web-service interface is provided, one or more Web-service queries are created at 420 based on the original data request. When the Web-portal does not provide data interface, e.g., Web-service, to retrieve data, one or more data scraping queries may be created at 425 based on the original data request. The data scraping queries would allow extracting the requested data via human-readable interface of the selected publisher. A practitioner would recognize that the publisher may provide other types of interfaces, and that corresponding query or set of queries may be generated to retrieve the requested data.

The created one or more Web-service or data scraping queries are routed to the corresponding interface of the selected publisher at 430. The data received by the publisher in response to the queries is consolidated at 435. The actions of process 400 referenced with blocks 410 to 435 are repeated for as long as the check at 440 confirms that there is another known or registered publisher providing data of the requested type. The data received from a next publisher may be consolidated with the previously received data from the previously selected publisher at 435. Process 400 ends at 445 with responding to the original data request received at 405. The response may include the consolidated data retrieved from the publishers.

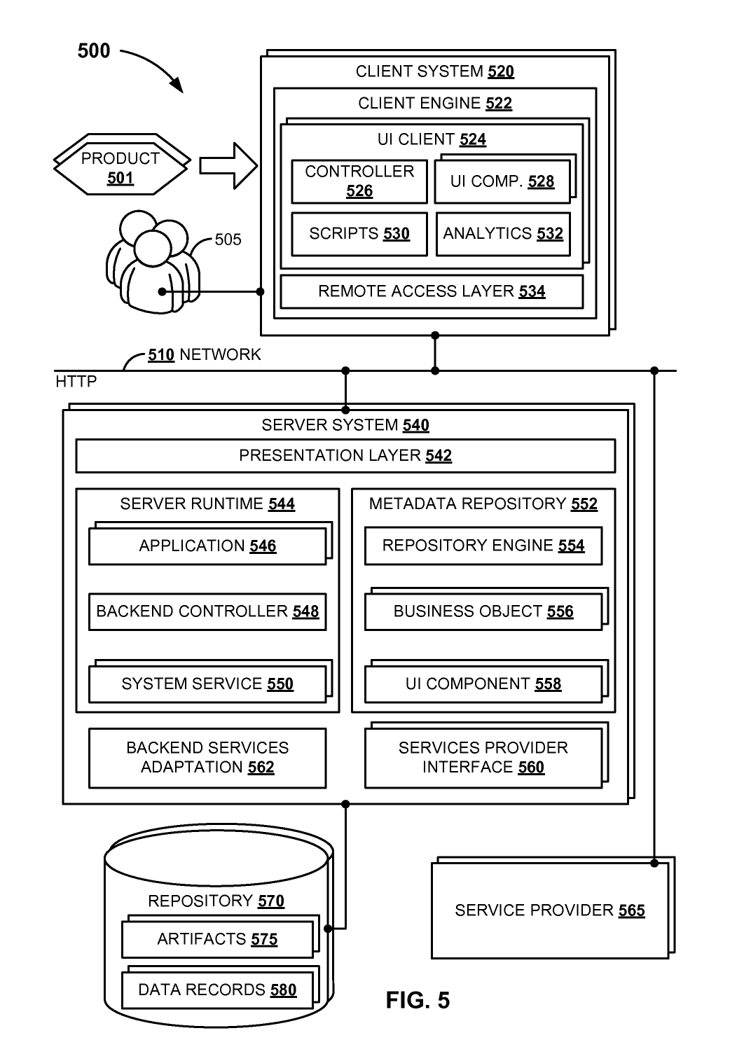

FIG. 5 is a block diagram showing computer system landscape 500 where captured product information is augmented, according to one embodiment. The computer system landscape 500 includes a rather simplified example of classic client-server architecture. One or more shareholders or users 505 operate on one or more client systems 520. Users 505 may request different services or execute various operations available within client systems 520, or provided by one or more server systems 540 via network 510. In one embodiment, one or more of client systems 520 may be mobile devices, such as smart phone, tablet computer, netbook, etc. The illustrated server systems 540 represent one or more backend nodes in the computer system landscape 500.

The client systems 520 and the server system nodes 540 communicating via network 510 may define a number of different computer system environments. Some of the elements of the computer system landscape 500 resemble the structure and functionality of software modules developed by SAP AG. However, structures with similar functionalities could be found in software products developed by other vendors, as well. Alternative embodiments may utilize other kinds of computer system architectures.

The involved client systems 520 may have similar or different structures where one or more of the illustrated modules are replicated. One or more users 505 may operate within one or more instances of user interface (UI) client 524 of one or more of client systems 520. Different users 505 may exclusively access different instances of the UI client 524 within a same client system 520.

In one embodiment, any of client systems 520 may execute a standalone client application, e.g., client engine 522, to interact with the backend server system 540. Alternatively, an intermediate layer may be downloaded to any of the client systems 520 as an extension of a running browser client. Such intermediate layer may also be illustrated as client engine 522. The standalone client application and the intermediate layer may have similar components and functionality. Client engine 522 takes responsibility for rendering the necessary client functionality, and also for communicating with server systems 540 via network 510 when necessary.

The client engine 522 includes UI client instances or sessions 524 that may also embed into a browser integrated framework. Depending on the client device, client engine 522 and UI clients 524 may be implemented as mobile apps, according to one embodiment. Alternatively, the UI client 524 may be a part of any popular browser integrated framework, e.g. Silverlight® provided by Microsoft Corp, Flex® provided by Adobe Systems Inc., JavaFX® originally developed by Sun Microsystems Inc., etc. In one embodiment, the client engine 522 and UI client 524, respectively, may be desktop application, for example, a .NET® application rendering a UI through a Windows Presentation Foundation (WPF) system. The UI client 524 accesses data at the backend 540 through remote access layer 534 via network 510. In one embodiment, no dedicated UI server or client programs are needed. The communication with the backend 540 may include extracting, storing and updating data. The data may be transported to repositories 570, especially when backend 540 implements a number of server nodes in separate computer system environments.

In one embodiment, users 505 generate services requests at UI client 524. UI components module 528 instantiates one or more appropriate graphical user interface (GUI) screens or controls in response to the user request. The behavior of the UI components is managed by controller 526. The controller 526 makes sure that all instantiated controls in the UI components 528 are initialized. The controller is also responsible for the execution of any configured operation triggered by events corresponding to the instantiated controls. In case when some of the operations involve execution of script segments, the controller 526 may trigger the execution of these scripts via scripts module 530. In one embodiment, scripts module 530 is a frontend scripting engine. Analytics module 532 may be used for frontend data processing when necessary. Thus for example, user 505 may capture information for one or more of products 501, e.g., through a Web-camera snapshot.

In one embodiment, the backend 540 utilizes presentation layer 542 to connect to the Internet and/or to other public or private networks, and to provide access for the UI client sessions 524 to underlying business functions and data structures. For example, the presentation layer 542 may generate the UI object model underlying the UI controls instantiated in the UI components module 528 at the client systems 520. In one embodiment, presentation layer 542 may be part of the server runtime 544.

The server runtime 544 provides environment where one or more software applications 546 are executed. For example, the applications 546 may provide a number of business services to the users 505, where various operation requests related to the business services are created at client systems 520. The requests are translated to corresponding process tasks performed by the applications 546 executed in server runtime 544. In one embodiment, the captured information for product 501 is translated by applications 546 to data queries.

In one embodiment, the server runtime 544 includes backend controller 548 for one or more UI client sessions 524 to handle the requested UI components, e.g., when a UI client session 524 triggers an initialization of a UI component for the first time. The backend controller 548 may manage the collaboration between the requested UI components and one or more underlying business objects. System services 550 in the server runtime 544 may be used to administer the characteristics of the server runtime 544, e.g., its engine parameters, the user access to one or more components, the processes execution, the communication with other runtime environments, like, external systems, databases, etc. In one embodiment, system services 550 may also provide deployment, setup and change management of software components.

Metadata repository 552 is generally the place where metadata about the computer programs deployed in the server system 540 are preserved, according to one embodiment. There are different kinds of metadata that could be maintained by the metadata repository 552. For example, the repository 552 keeps the description of the business objects 556 underlying the applications 546. In one embodiment, metadata repository 552 keeps description of the available UI components 558 and the relationships between them as designed.

Repository engine 554 may manage the metadata and the collaboration with the server runtime 544, on one hand, and with various service providers 565 on the other hand. The service providers 565 may render services to the backend 540 as defined in the metadata. The service providers 565 could be available through various service provider interfaces 560. Further, service providers can be internal and/or external to the backend 540. In one embodiment, service providers may be queried by the server system 540 (e.g., by the applications 546) for product data. In one embodiment, service providers 565 may render additional functionality, including UI components, to the server system 540 via metadata repository engine 554. Backend services adaptation 562 represents a layer that helps to adjust deployed functionality or UI components and some functionality or UI components rendered by service providers 565 to a set of normalized business objects available at the server system 540.

In a multi-server system environment, e.g., in a cluster of more than one server system nodes 540, repository 570 may be used to keep different kinds of common data, including programming code, business data, metadata, etc. (e.g., artifacts 575). In one embodiment, one or more different repositories 570 may be assigned to different computer system environments defined in the computer system landscape 500.

In one embodiment, users 505 may capture information for products 501 by manipulating UI components 528 associated with particular application, software tool. The UI components 528 associated with particular applications or tools may utilize various hardware capabilities, either built-in or external to client systems 520, to capture the product information, e.g., scanner, camera, wireless communication module, radio tag reader, etc. The UI components 528 may be available within GUI environment of the UI client 524. The manipulations of the UI components 528 may trigger execution of various system or application procedures in server runtime 544. Further, the manipulations of the UI components 528 may lead to communication with the repository 575, e.g., references to the artifacts 575 and/or manipulations to records 580. In one embodiment, artifacts 575 contain parameters associated with the executed software, e.g., source code, metadata descriptions etc. Data records may contain business data, e.g., associated with the business objects.

For example, by manipulating UI components 528 or by directly entering data, a user 505 may submit information for product 501. The captured information may be sent to the server system 540, e.g., via HTTP network. At server system, one or more applications 546 may use the captured information to identify the product 501. If the captured information is not sufficient for the identification, additional data for the product may be requested from the client system 520. Respectively, if there is no additional data for the product available, client system 520 may prompt through the respective UI client 524 (e.g., UI components 528) the user 505 to capture or enter additional data for the product 501. Once the product 501 is identified, server system may generate queries for retrieving product data from various data sources, such as repository 570 (e.g., data records 580), internal and/or external service providers 565 (e.g., Web portals), etc.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. Examples of computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

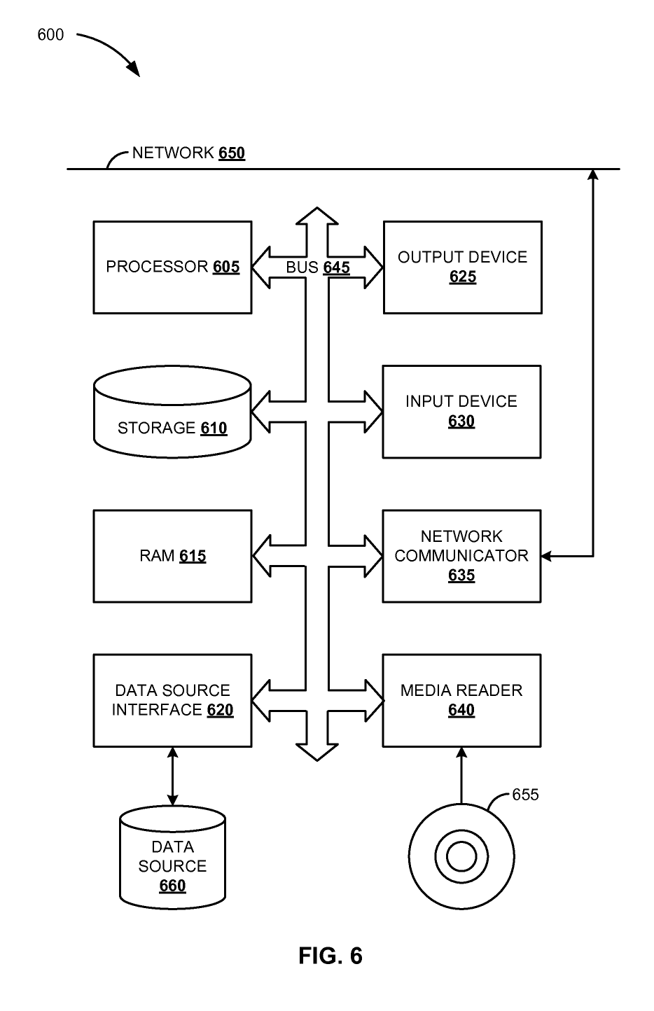

FIG. 6 is a block diagram of an exemplary computer system 600. The computer system 600 includes a processor 605 that executes software instructions or code stored on a computer readable storage medium 655 to perform the above-illustrated methods. The computer system 600 includes a media reader 640 to read the instructions from the computer readable storage medium 655 and store the instructions in storage 610 or in random access memory (RAM) 615. The storage 610 provides a large space for keeping static data where at least some instructions could be stored for later execution. The stored instructions may be further compiled to generate other representations of the instructions and dynamically stored in the RAM 615. The processor 605 reads instructions from the RAM 615 and performs actions as instructed. According to one embodiment, the computer system 600 further includes an output device 625 (e.g., a display) to provide at least some of the results of the execution as output including, but not limited to, visual information to users and an input device 630 to provide a user or another device with means for entering data and/or otherwise interact with the computer system 600. Each of these output devices 625 and input devices 630 could be joined by one or more additional peripherals to further expand the capabilities of the computer system 600. A network communicator 635 may be provided to connect the computer system 600 to a network 650 and in turn to other devices connected to the network 650 including other clients, servers, data stores, and interfaces, for instance. The modules of the computer system 600 are interconnected via a bus 645. Computer system 600 includes a data source interface 620 to access data source 660. The data source 660 can be accessed via one or more abstraction layers implemented in hardware or software. For example, the data source 660 may be accessed via network 650. In some embodiments the data source 660 may be accessed by an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open DataBase Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the presented embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limiting to the precise forms disclosed. While specific embodiments and examples are described herein for illustrative purposes, various equivalent modifications are possible, as those skilled in the relevant art will recognize. These modifications can be made in light of the above detailed description. Rather, the scope of the specification is to be determined by the following claims, which are to be interpreted in accordance with established doctrines of claim construction.

What is claimed is:

1. A computer system to augment information related to a product, the system comprising:
a memory to store computer executable instructions; and
a processor coupled to the memory and operable to execute the instructions to:
receive the information related to the product captured at a client device,
select an interface to at least one data portal based on the received information,
generate at least one data query based on the received information, wherein the at least one data query is formatted based at least in part on the selected interface, and
augment the received information related to the product with data retrieved from the at least one data portal by receiving through the selected interface results from executing the at least one data query.

2. The system of claim 1, wherein receiving the information related to the product comprises:
evaluating the received information to identify the product; and
prompting the client device to capture additional information related to the product when the received information also identifies at least one other product.

3. The system of claim 1, wherein selecting the interface comprises:
creating at least one registration of the at least one data portal, wherein the at least one registration specifies at least one type of data stored at the at least one data portal, and at least one type of interface to access the data.

4. The system of claim 1, wherein augmenting the received information related to the product comprises:
consolidating the data retrieved from the at least one data portal by the at least data query.

5. A non-transitory computer readable medium storing instructions, which when executed cause a computer system to:
receive a data request including information related to a product captured at a client device;
select a publisher of product data based on the data request;
route at least one data query to the publisher, wherein the at least one data query is formatted based at least in part on the data request; and
consolidate data received from the publisher in response to the at least one data query.

6. The computer readable medium of claim 5, wherein receiving the data request comprises:
requesting additional information related to the product from the client device when the received information identifies the product indistinctively.

7. The computer readable medium of claim 5, wherein selecting the publisher comprises:
reading at least one property associated with the data request, wherein the at least one property specifies the type of requested data; and
comparing the at least one property with at least one registration of at least one publisher.

8. The computer readable medium of claim 7 storing instructions, which when executed cause the computer system further to:
create the at least one registration of the at least one publisher, wherein the at least one registration specifies at least one type of data stored by the at least one publisher and at least one type of interface to access the data; and
dynamically update the at least one registration of the at least one publisher.

9. The computer readable medium of claim 5, wherein routing the at least one query comprises:
generating the at least one query, wherein the format of the at least one query corresponds to an interface to access data of the publisher.

10. The computer readable medium of claim 5, wherein consolidating the data received from the publisher comprises:
combining the data received from the publisher with data related to the product received from a different publisher.

11. The computer readable medium of claim 5, wherein consolidating the data received from the publisher comprises:
comparing the data received from the publisher with data related to a different product.

12. The computer readable medium of claim 5 storing instructions, which when executed cause the computer system further to:
augment the received information related to the product with the consolidated data.

13. A computer implemented method of augmenting product information comprising:
capturing information related to a product at a mobile device;
routing via a computer network at least one data query to at least one data source, wherein the at least one data query is formatted based at least in part on the captured information, and wherein the at least one data source is chosen based at least in part on a characteristic of the at least one data source; and
at the mobile device, augmenting by a processor the captured information related to the product with data retrieved from the at least one data source in response to the at least one data query.

14. The method of claim 13, wherein capturing the information related to the product comprises:
scanning one of a radio tag, code, shape or color of the product; and
prompting input of additional information related to the product at the mobile device when the captured information is not sufficient to identify the product.

15. The method of claim 13, wherein routing the at least one data query to the at least one data source comprises:
associating at least one property of interest with the product; and
selecting the at least one data source based on a correspondence between at least one type of data at the at least one data source and the at least one property of interest.

16. The method of claim 15 further comprising:
creating a registration of the at least one data source, wherein the registration includes the characteristic of the at least one data source; and
dynamically updating the registration based on a change of the characteristic of the at least one data source.

17. The method of claim 13, wherein routing the at least one data query to the at least one data source comprises:
generating the at least one query, wherein the format of the at least one query corresponds to at least one interface to access the data in the at least one data source.

18. The method of claim 13, wherein augmenting the captured information related to the product comprises:
combining the data received from the publisher with data retrieved from a different data source.

19. The method of claim 13, wherein augmenting the captured information related to the product comprises:
comparing the data received from the at least one data source with data related to a different product.

20. The method of claim 13 wherein augmenting the captured information related to the product comprises:
augmenting the captured information related to the product with the data retrieved from the at least one data source on a display screen of the mobile device.
